(19) United States
(12) Patent Application Publication
(10) Pub. No.: US 2024/0129886 A1
(43) Pub. Date: Apr. 18, 2024

(54) Device and Method of Managing Mobile Communication Entities in an Ultra-Wideband Transceiver

(71) Applicant: LEGIC Identsystems AG, Wetzikon (CH)

(72) Inventors: Markus Bingesser, Eglisau (CH); Peter Plüss, Tann (CH); Marcel Plüss, Tann (CH)

(21) Appl. No.: 18/277,118

(22) PCT Filed: Feb. 15, 2022
(86) PCT No.: PCT/EP2022/053614

§ 371 Date: Aug. 14, 2023

(30) Foreign Application Priority Data
Feb. 15, 2021 (CH) CH00144/21

(51) Int. Cl. H04W 64/00; G01S 5/02

(52) U.S. Cl. CPC H04W 64/003; G01S 5/0269; G01S 13/0209

(57) ABSTRACT

Proposed is a method and an ultra-wideband transceiver for managing mobile communication entities comprising the following steps: receiving wirelessly from an ultra-wideband mobile communication device an ultra-wideband transmission; determining a distance of the ultra-wideband mobile communication device from the ultra-wideband transceiver, and device identification information of the ultra-wideband mobile communication device; and maintaining an inventory list of ultra-wideband mobile communication devices, by storing an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver.

### FIELD OF THE INVENTION

The present invention relates to a transceiver device for managing mobile communication entities in an ultra-wideband transceiver. The present invention also relates to a method for managing mobile communication entities in an ultra-wideband transceiver.

### BACKGROUND OF THE INVENTION

Ultra-wideband (UWB) is a wireless radio communication technology which has some properties which make it a good candidate for transmissions over short to medium distances, in particular for a transmitter and a receiver within line of sight of each other. UWB transmissions T can be configured for low power and high bandwidth, and because they allow the receiver to determine a relatively precise time of arrival of an UWB transmission T, they enable a distance between the transmitter and the receiver to be determined, for example using a round trip time of flight calculation or by having synchronized clocks. Because of the low power capabilities of UWB technology, it is particularly useful for use with mobile communication devices operating on battery power.

### SUMMARY OF THE INVENTION

It is an object of embodiments disclosed herein to provide a transceiver device and a method for managing mobile communication entities in an ultra-wideband transceiver which overcome one or more of the disadvantages of the prior art.

In particular, it is an object of embodiments disclosed herein to provide a transceiver device and a method for managing mobile communication entities in an ultra-wideband transceiver which is more flexible and efficient than those known from the prior art.

An ultra-wideband transceiver comprises an electronic circuit and a data store, wherein the electronic circuit is configured to execute a number of steps. The electronic circuit is configured to receive wirelessly from an ultra-wideband mobile communication device an ultra-wideband transmission, and to determine, from the ultra-wideband transmission a distance of the ultra-wideband mobile communication device from the ultra-wideband transceiver, and device identification information of the ultra-wideband mobile communication device. The electronic circuit is configured to maintain, in the data store an inventory list of ultra-wideband mobile communication devices, by storing in the inventory list an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver. In an embodiment, the electronic circuit is further configured to execute the step of determining whether the distance of the ultra-wideband mobile communication device from the ultra-wideband transceiver is within a defined zone boundary of the ultra-wideband transceiver, prior to storing the entry for the ultra-wideband mobile communication device. A further step includes storing the entry for the ultra-wideband mobile communication device, if the distance of the ultra-wideband mobile communication device from the ultra-wideband transceiver is within the defined zone boundary, and not storing the entry for the ultra-wideband mobile communication device, if the distance of the ultra-wideband mobile communication device from the ultra-wideband transceiver is not within the defined zone boundary.

In an embodiment, the electronic circuit of the ultra-wideband transceiver is further configured to execute the step of determining whether the ultra-wideband mobile communication device has access permission, prior to storing the entry for the ultra-wideband mobile communication device. The electronic circuit is configured to execute the step of storing the entry for the ultra-wideband mobile communication device, if the ultra-wideband mobile communication device has access permission, and to not storing the entry for the ultra-wideband mobile communication device, if the ultra-wideband mobile communication device does not have access permission.

In an embodiment, the electronic circuit is further configured to execute the steps of determining whether the ultra-wideband mobile communication device has access permission, establishing a secured communication session with the ultra-wideband mobile communication device, if the ultra-wideband mobile communication device has access permission, and not establishing a communication session with the ultra-wideband mobile communication device, if the ultra-wideband mobile communication device does not have access permission.

In an embodiment, determining whether the ultra-wideband mobile communication device has access permission, comprises the ultra-wideband transceiver receiving a cryptographic key from the ultra-wideband mobile communication device and authenticating the cryptographic key.

In an embodiment, the ultra-wideband transceiver is connected to an access control terminal. The access control terminal is configured to provide physical access to an access controlled area to a person or vehicle in possession of the ultra-wideband mobile communication device with access permission. For example, the access control terminal is connected to an actuator of a movable barrier (e.g., a door, gate, or turn-stile). Preferably, the ultra-wideband transceiver is configured to monitor a distance and/or a position of the ultra-wideband communication device relative to a barrier and provide access if the distance and/or position is below a pre-defined threshold or within a pre-defined area, respectively. The inventory list storing ultra-wideband mobile communication devices with access permission thereby enables for a faster and more efficient access control and passage through the barrier.

In an embodiment, the ultra-wideband transceiver is fixedly installed in a wall or ceiling of a room inside or adjacent to an access controlled area.

In an embodiment, the electronic circuit is further configured to execute the steps of establishing a secured communication session with the ultra-wideband mobile communication device and determining whether the ultra-wideband mobile communication device has access permission. The electronic circuit is configured to execute the step of terminating the secured communication session with the ultra-wideband mobile communication device if the ultra-wideband mobile communication device does not have access permission.

In an embodiment, the electronic circuit is further configured to execute the step of establishing a secured communication session with a defined maximum number of ultra-wideband mobile communication devices entered in the inventory list, whereby priority for establishing a secured communication session is given to the ultra-wideband mobile communication devices reciprocal to their respective distance from the ultra-wideband transceiver. Thereby, a particular ultra-wideband mobile communication device closer to the ultra-wideband transceiver than another ultra-wideband mobile communication device will be given priority for establishing a secured communication session.

In an embodiment, the electronic circuit is configured to execute the step of performing an authentication protocol for establishing authenticity of a particular ultra-wideband mobile communication device prior to establishing a communication session with the particular ultra-wideband mobile communication device.

In an embodiment, the electronic circuit is configured to execute the step of maintaining the inventory list by determining periodically for the ultra-wideband mobile communication devices their presence and distances from the ultra-wideband transceiver.

In an embodiment, the electronic circuit is configured to execute the step of maintaining the inventory list by removing the entry of a particular ultra-wideband mobile communication device from the inventory list, in case the particular ultra-wideband mobile communication device is no longer present in a communication range of the ultra-wideband transceiver or the distance of the particular ultra-wideband mobile communication device from the ultra-wideband transceiver is not within a defined zone boundary.

In an embodiment, the electronic circuit is further configured to execute the steps of determining from the ultra-wideband transmission position information of the ultra-wideband mobile communication device, and storing the position information in the inventory list in the entry for the ultra-wideband mobile communication device.

In an embodiment, the electronic circuit is configured to execute the steps of determining the position information periodically for the ultra-wideband mobile communication device; determining from the position information movement information for the ultra-wideband mobile communication device; and storing in the inventory list the entry for the ultra-wideband mobile communication device depending on the movement information for the ultra-wideband mobile communication device.

In an embodiment, the electronic circuit is further configured to execute the step of determining statistical information for the ultra-wideband mobile communication device, the statistical information comprising at least a number of entries of the ultra-wideband mobile communication device in a defined zone around the ultra-wideband transceiver. Further steps include storing the statistical information in the inventory list in the entry for the ultra-wideband mobile communication device and storing in the inventory list the entry for the ultra-wideband mobile communication device depending on the statistical information for the ultra-wideband mobile communication device.

In an embodiment, the electronic device is configured to execute the step of determining the device identification information of the ultra-wideband mobile communication device by determining a communication address of the ultra-wideband communication in the ultra-wideband transmission.

In an embodiment, the communication address of the ultra-wideband communication in the ultra-wideband transmission is encrypted.

In an embodiment, the electronic circuit is configured to execute the step of determining the device identification information of the ultra-wideband mobile communication device by determining in the ultra-wideband transmission a randomized unique identifier of the ultra-wideband communication.

In addition to an ultra-wideband transceiver, the present invention also relates to a method of managing mobile communication entities in an ultra-wideband transceiver, the method comprising an electronic circuit of the ultra-wideband transceiver executing a number of steps, including receiving wirelessly from an ultra-wideband mobile communication device an ultra-wideband transmission and determining from the ultra-wideband transmission a distance of the ultra-wideband mobile communication device from the ultra-wideband transceiver, and device identification information of the ultra-wideband mobile communication device. The steps include maintaining in a data store of the ultra-wideband transceiver an inventory list of ultra-wideband mobile communication devices, by storing in the inventory list an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver.

In an embodiment, the method includes the electronic circuit of the ultra-wideband transceiver executing the steps of one or more of the embodiments above.

In addition to an ultra-wideband transceiver and a method of managing mobile communication entities in an ultra-wideband transceiver, the present disclosure also relates to an access control terminal comprising an ultra-wideband transceiver as described herein.

In addition to an ultra-wideband transceiver, an access control terminal comprising an ultra-wideband transceiver, and a method of managing mobile communication entities in an ultra-wideband transceiver, the present disclosure also relates to an access control system comprising an ultra-wideband transceiver and one or more ultra-wideband communication devices.

### BRIEF DESCRIPTION OF THE DRAWINGS

The herein described disclosure will be more fully understood from the detailed description given herein below and the accompanying drawings which should not be considered limiting to the disclosure described in the appended claims. The drawings in which:

FIG. 1: shows a diagram illustrating schematically an ultra-wideband transceiver and a number of ultra-wideband mobile communication devices arranged around the ultra-wideband transceiver;

FIGS. 2-7: show flow diagrams illustrating a number of steps for managing an inventory list of ultra-wideband mobile communication devices in an ultra-wideband transceiver; and

FIGS. 8, 9: show illustrations of an ultra-wideband transceiver in an access control scenario with defined zones and barriers.

### DETAILED DESCRIPTION OF EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

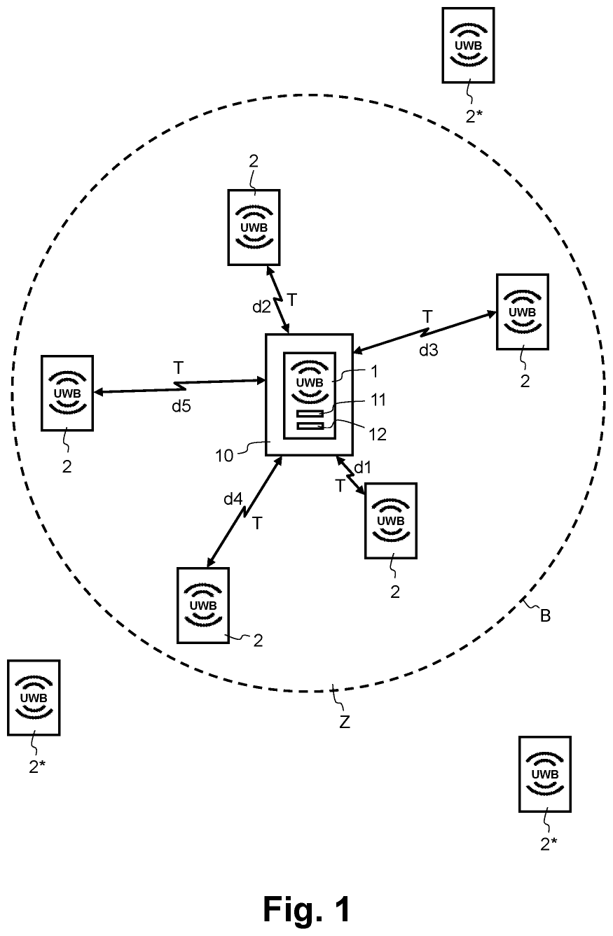

FIG. 1 shows a schematic top view of an ultra-wideband (UWB) transceiver 1 with multiple UWB mobile communication devices 2 located around the UWB transceiver 1. The UWB transceiver 1 is arranged in or adjacent to a physical space, for example on a wall or ceiling of a room of a building. Additionally, the UWB transceiver 1 is situated in, or next to, a defined zone Z which has a boundary B. Some of the UWB mobile communication devices 2 are in the defined zone Z, while other UWB mobile communication devices 2* are outside the defined zone Z. The defined zone Z is, depending on the embodiment, defined using a two-dimensional or three-dimensional boundary B. In an embodiment, the boundary B is defined using a threshold distance d1, d2, d3, d4, d5 from the UWB transceiver 1. UWB mobile communication devices 2 closer to the UWB transceiver 1 than the threshold distance are in the defined zone Z, and UWB mobile communication devices 2* further than the threshold distance are outside the defined zone Z.

In an embodiment, the UWB transceiver 1 is a mobile UWB transceiver 1. The mobile UWB transceiver 1 is mobile in that it is moveable and not fixedly installed. For example, the mobile UWB transceiver 1 is connected to or incorporated into a mobile device, such as a laptop, a smart phone, a smart watch, or a key fob. In another example, the mobile UWB transceiver 1 is attached to a transportable or moveable object, such as an appliance, a machine, a container, or a vehicle.

The boundary B is, in an example, a more complex shape than a circle or sphere, for example a rectangle or rectangular box. Depending on the embodiment, the defined zone Z is partitioned into two or more sub-zones using partition boundaries which, for example, intersect physical barriers or follow features of the physical space.

The UWB transceiver 1 comprises an electronic circuit 11 and a data store 12. The electronic circuit is configured to carry out steps and/or functions as described in the present disclosure and is, in an embodiment, a processor, such as a system on a chip (SoC), a central processing unit (CPU), or microprocessor. The data store 12 comprises volatile and/or non-volatile memory, for example flash memory and is configured to store an inventory list comprising device identification information of a plurality of UWB mobile communication devices 2 and a distance d1, d2, d3, d4, d5 associated with the device identification information of each UWB mobile communication device 2. Additionally, the UWB transceiver 1 comprises a battery. Alternatively, the UWB transceiver 1 is provided electrical power via a power cable.

In an embodiment, the inventory list is a data structure, comprising, for example, a linear data structure such as an array or a list, a tree structure such as a binary tree or heap, a hash-based structure, and/or a graph. The inventory list comprises a plurality of entries, each entry comprising one or more data types. Preferably, each entry of the inventory list relates to a particular UWB mobile communication device 2, and comprises device identification information of the particular UWB mobile communication device 2 and a distance d1 associated with the particular UWB mobile communication device 2.

In a preferred embodiment, the device identification information includes an address, for example a media access control (MAC) address.

In an embodiment, the inventory list, in particular an entry of the inventory list, comprises capability information relating to whether the UWB mobile communication device 2 is capable of determining, for example, a distance or optionally also an angle of arrival.

In an embodiment, the inventory list, in particular an entry of the inventory list, comprises a status of the UWB mobile communication device 2, for example a battery status.

In an embodiment, the inventory list and/or one or more entries of the inventory list are stored in an encrypted manner using an encryption key stored in the UWB transceiver 1. Preferably, the encryption key is stored in a hardware secure component of the UWB transceiver 1, which hardware secure component is part of the electronic circuit 11.

The secure component is, for example, implemented as a separate integrated circuit connected to the processor, or implemented as part of the processor. The secure component is, depending on the embodiment, an Embedded Secure Element (eSE), a Universal Integrated Circuit Card (UICC), an Embedded UICC (eUICC), or a software-emulated secure component.

In an embodiment, the inventory list and/or one or more entries of the inventory list are encoded using, for example, TLV (type-length-value or tag-length-value) or ASCII (American Standard Code for Information Interchange).

The UWB mobile communication device 2 comprises an UWB transceiver. Further, the UWB mobile communication device 2 comprises a processor connected to the UWB transceiver, such as a system on a chip (SoC), a central processing unit (CPU), or other microprocessor. Additionally, the UWB mobile communication device 2 comprises memory, such as flash memory.

The UWB mobile communication device 2 comprises a battery and is small and portable such that it may be carried on a person or in a person's belongings. For example, the UWB mobile communication device 2 is a smart phone. Alternatively, the UWB mobile communication device 2 is a key fob, a smart watch, a tablet, or other type of portable electronic device with UWB capabilities.

The distance d1, d2, d3, d4, d5 between the UWB transceiver 1 and the UWB mobile communication device 2 is determined using the propagation time of one or more UWB transmissions T between the UWB transceiver 1 and the UWB mobile communication device 2. Determining a distance d1, d2, d3, d4, d5 using the propagation time of an UWB transmission T comprises measuring the time required for an UWB signal to travel from the UWB transceiver 1 to the UWB communication module of the UWB mobile communication device 2 and/or the time required for an UWB signal to travel from the UWB mobile communication device 2 to the UWB transceiver 1. Depending on the embodiment, the time difference is a “one-way time-of-flight” time difference between the UWB transceiver 1 sending a first UWB transmission T and the UWB mobile communication device 2 receiving the first UWB transmission T, or a “round-trip time-of-flight” time difference, in which a second UWB transmission T takes place from the UWB mobile communication device 2 to the UWB transceiver 1 either prior to, or after the first UWB transmission T. In the “one-way time-of-flight” scenario, the UWB transceiver 1 and the UWB mobile communication device 2 need to be provided with tightly synchronized clocks for accurately determining the distance d1, d2, d3, d4, d5 using a time difference. In the latter case of a “round-trip time-of-flight” calculation, there is stored, either in the UWB mobile communication device 2 or the UWB transceiver 1, an accurate representation of the processing time, i.e. the time it takes between the reception of the first UWB transmission T and the sending of the second UWB transmission T, which processing time allows for accurately determining the distance d1, d2, d3, d4, d5. Measurement of a time required for the signal to travel from the UWB transceiver 1 to the UWB mobile communication device 2 and back “round-trip time-of-flight” is advantageous as it does not require the precise synchronization of clock signals of the UWB transceiver 1 and the UWB mobile communication device 2.

In an embodiment, the UWB transceiver 1 comprises multiple antennas and associated UWB radio circuitry arranged such that, in addition to the distance d1, d2, d3, d4, d5 between the UWB transceiver 1 and the UWB mobile communication device 2, position information of the UWB mobile communication device 2 relative to the UWB transceiver 1 is determined using multilateration and/or multiangulation. Alternatively, or additionally, the position information relates to an absolute position of the UWB mobile communication device 2 in the physical space, which absolute position is determined in the UWB transceiver 1 further using installation location information relating to an installed location of the UWB transceiver 1. Position information includes one or more of the following: an angle, such as an azimuthal angle between an azimuthal axis of the UWB transceiver 1 and a location of the UWB mobile communication device 2. The location is defined by 2D or 3D coordinates. Using positional information which includes an angle and/or a location is advantageous as it allows for the boundary B of the defined zone Z to have a more complex shape. In particular, it is possible to have an elongated defined zone Z or a rectangular defined zone Z. Additionally, it is possible to configure the defined zone Z such that it is adjacent to the installed location of the UWB transceiver 1. Further, it is possible to record the position information of each UWB mobile communication device 2 over time to track a movement of the UWB mobile communication device 2.

For example, the 2D coordinates include an azimuthal angle, a radial distance, an x-distance, and/or a y-distance. For example, the 3D coordinates include an azimuthal angle, an altitude angle, a radial distance, an x-distance, a y-distance, and/or a z-distance.

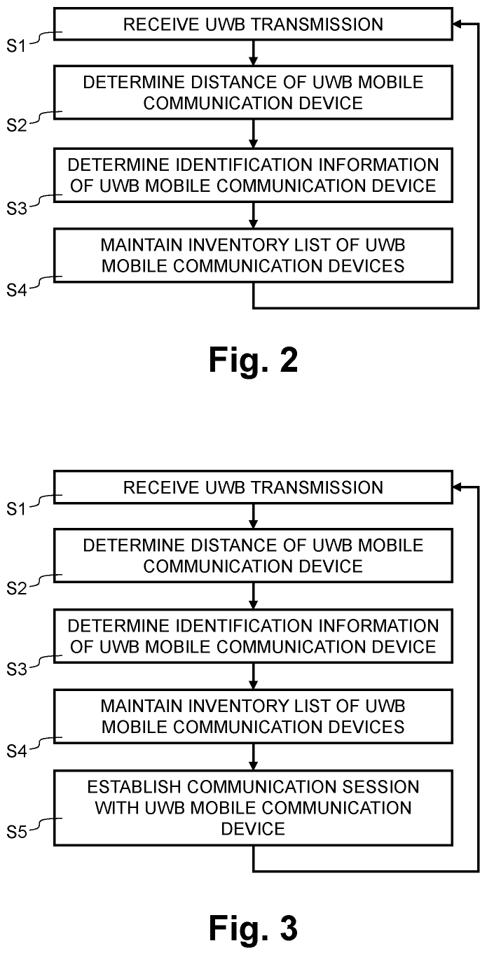

FIGS. 2 to 7 show flow charts illustrating sequences of steps executed by the UWB transceiver according to embodiments of the present invention. FIG. 2 will be described in detail, whereas FIGS. 3 to 7, for the sake of brevity, will be described only to the extent that they describe alternative or additional steps to those previously described. The person skilled in the art knows that at least some of the steps shown in FIGS. 2 to 7 and described below can be executed in an alternative order than illustrated, or be inserted into other figures which do not illustrate a particular step without deviating from the scope of the invention.

FIG. 2 shows a flow chart illustrating a number of steps executed by the UWB transceiver 1. In step S1, the UWB transceiver 1 receives an UWB transmission T from the UWB mobile communication device 2. Depending on the embodiment of the invention, prior to receiving the UWB transmission T, the UWB transceiver 1 transmitted an UWB transmission T to the UWB mobile communication device 2, for example to enable a “round-trip” time of flight determination as described above.

In step S2, the distance d1, d2, d3, d4, d5 between the UWB transceiver 1 and the UWB mobile communication device 2 is determined.

In an embodiment, the distance d1, d2, d3, d4, d5 refers to a distance between the UWB mobile communication device 2 and one or more barriers associated with the UWB transceiver 1.

In an embodiment, the distance d1, d2, d3, d4, d5 is determined using secure ranging, in which the UWB transmission T is encrypted using a cryptographic ranging key. The cryptographic ranging key is, depending on the embodiment, part of a symmetric key-pair or an asymmetric key-pair.

In step S3, device identification information of the UWB mobile communication device 2 is determined using the received UWB transmission(s) T. The device identification information is contained in the received UWB transmission(s) T from the UWB mobile communication device 2. The device identification information comprises one or more of the following: a MAC address, device type information, device version information, a device serial number, or a device identifier. In an embodiment, the device identification information comprises a communication address of the UWB mobile communication device 2 encrypted in the UWB transmission T. In an embodiment, the UWB transceiver 1 is configured to determine the device identification information by determining a randomized unique identifier of the communication device 2.

In step S4, the UWB transceiver 1 maintains the inventory list. The UWB transceiver maintains the inventory list by adding, to the inventory list in the data store 12, an entry comprising the device identification information and the distance d1, d2, d3, d4, d5 of the UWB mobile communication device 2. Depending on the embodiment, the inventory list may be used for enabling further functionality, for example ranking the UWB mobile communication devices 2 in the inventory list by ascending order of distance d1, d2, d3, d4, d5.

In an embodiment, in step S2, the UWB transceiver 1 determines the position information of the UWB mobile communication device 2 and stores the position information in the inventory list in the entry for the communication device 2.

In an embodiment where the position information is determined, priority for establishing the secured communication session is given reciprocal to a proximity of the UWB mobile communication devices 2 to a pre-determined location. The pre-determined location is, for example, a computerized terminal or a barrier (such as a door, gate, or lift).

In an embodiment, position information determined at a plurality of time-points during reception of the UWB transmissions T from the UWB mobile communication device 2 is used to determine movement information of the mobile communication device 2. The movement information comprises an initial position, a speed, a direction, and/or a velocity of movement of the UWB mobile communication device 2. The entry in the inventory list including the position information and/or the movement information is stored depending on the movement information. For example, if the UWB mobile communication device 2 is moving toward the UWB transceiver 1, the entry is stored, however, if the UWB mobile communication device 2 is moving away from the UWB transceiver 1, the entry is not stored. In another example, if the UWB mobile communication device 2 is entering the defined zone Z, the entry is stored, however if the UWB mobile communication device 2 is leaving the defined zone Z, the entry is not stored.

In an embodiment, statistical information for the UWB mobile communication device 2 is determined. The statistical information comprises a number of entries of the communication device 2 in the defined zone Z around the UWB transceiver 1. This allows the UWB transceiver to determine how frequently a particular UWB mobile communication device 2 enters the defined zone Z. For example, the inventory list comprises for each entry a counter which increments when the particular UWB mobile communication device 2 re-enters the defined zone Z. The entry is stored in the inventory list depending on the statistical information for the UWB mobile communication device 2.

The sequence of steps above may be executed in an alternate sequence. In particular, the order of steps S2 and S3 may be swapped, such that the UWB transceiver 1 is configured to determine device identification information prior to determining the distance d1, d2, d3, d4, d5.

The sequence of steps described above is executed in a continuous manner such that the UWB transceiver 1 adds to its inventory list in the data store 12 device identification information and distances d1, d2, d3, d4, d5 of UWB mobile communication devices 2.

In FIG. 3, steps S1 to S4 are the same as described above. An additional step S5 is shown in which a secured communication session is established between the UWB transceiver 1 and the UWB mobile communication device 2. The secured communication session is established such that further UWB transmissions T between the UWB transceiver 1 and the UWB mobile communication device 2 cannot be eavesdropped by a third party. The secured communication session is established, in an embodiment, by establishing a key for symmetrical encryption. The key is, for example, generated by the UWB transceiver 1 which encrypts the key using a public key of the UWB mobile communication device 2 received in a previous UWB transmission T. The encrypted key is then transmitted to the UWB mobile communication device 2 enabling the UWB mobile communication device 2 to decrypt the encrypted key using a private key which forms a private/public key pair with the public key.

Further, the UWB transceiver 1 is configured to determine whether the UWB mobile communication device 2 has access permission. In particular, the UWB mobile communication device 2 determines whether the device identification information matches pre-defined access criteria. The access criteria define, for example, one or more device types. The UWB transceiver 1 is configured, in an embodiment, to ignore (i.e. not to process) further any UWB transmissions T from UWB mobile communication devices 2 in communicative range of the UWB transceiver 1 which do not match the required access criteria. In an embodiment, determining whether the UWB mobile communication device 2 has access permission is performed directly after determining the device identification information of the UWB mobile communication device 2, such that an entry is not stored in the inventory list if the mobile communication device does not have access permission.

In an embodiment, an entry is stored or not stored depending on one or more additional pre-defined storage criteria, as defined in more detail below.

In an embodiment, the inventory list is ordered according to one or more pre-defined order criteria, as defined in more detail below. Depending on the embodiment, the order of entries in the inventory list is used by the UWB transceiver 1 to determine an order of processing messages and/or data related to two or more UWB mobile communication devices 2, or an action of an actuator, for example, of an access control terminal 10. In particular, a message and/or data related to a first UWB mobile communication device 2 with a first entry ordered higher in the inventory list is processed before a message and/or data related to a second UWB mobile communication device 2 with a second entry ordered lower in the inventory list.

The pre-defined storage criteria and/or access criteria are stored in the UWB transceiver 1, for example.

In an example, an entry is not stored and/or deleted if a time of last communication is older than a pre-defined time period.

In an example, the inventory list is ordered according to a time of last communication, such that a first entry of the inventory list corresponds to an UWB mobile communication device 2 communicated with most recently. For example, the inventory list is ordered according to distance, such that the first entry of the inventory list corresponds to an UWB mobile communication device 2 closest to either the UWB transceiver 1 itself or a barrier associated with the UWB transceiver 1.

In an example, the entry is not stored if the UWM mobile communication device 2 is not on a pre-defined priority list.

In an example, the inventory list is ordered according to a pre-defined priority list, the priority list comprising a plurality of identifiers of UWB mobile communication devices 2 in a particular order of priority, such that the first entry of the inventory list corresponds to an UWB mobile communication device 2 with a highest priority according to the priority list.

In an example, an entry is not stored and/or deleted if a response promptness of the UWB mobile communication device 2 is greater than a pre-defined response period.

In an example, the inventory list is ordered according to a response promptness of the UWB mobile communication devices 2, such that the first entry of the inventory list corresponds to an UWB mobile communication device 2 with a lowest response time.

In an example, an entry is not stored and/or deleted if a battery status of the UWB mobile communication device 2 is below a pre-defined battery threshold.

In an example, the inventory list is ordered according to a battery status of the UWB mobile communication devices 2, such that the first entry of the inventory list corresponds to an UWB mobile communication device 2 with a highest battery status.

In an example, the inventory list includes a counter indicating a number of times which a particular UWB mobile communication device 2 has been entered into the inventory list within a pre-defined period. Depending on the embodiment, the inventory list is ordered according to the counter, such that the first entry of the inventory list corresponds to an UWB communication device 2 with a highest counter value.

In an embodiment, the UWB transceiver 1 is further configured to execute the step S5 of establishing the secured communication session with a defined maximum number of mobile communication devices entered in the inventory list. Priority for establishing the secured communication session is given to the UWB mobile communication devices 2 reciprocal to their respective distance d1, d2, d3, d4, d5 from the UWB transceiver 1. This prioritization ensures preferential treatment for those UWB mobile communication devices 2 closest to the UWB transceiver and improves the performance of the UWB transceiver 1 particularly in embodiments where the UWB transceiver 1 is configured to authenticate the UWB mobile communication devices 2 for access control through a barrier arranged close to the UWB transceiver.

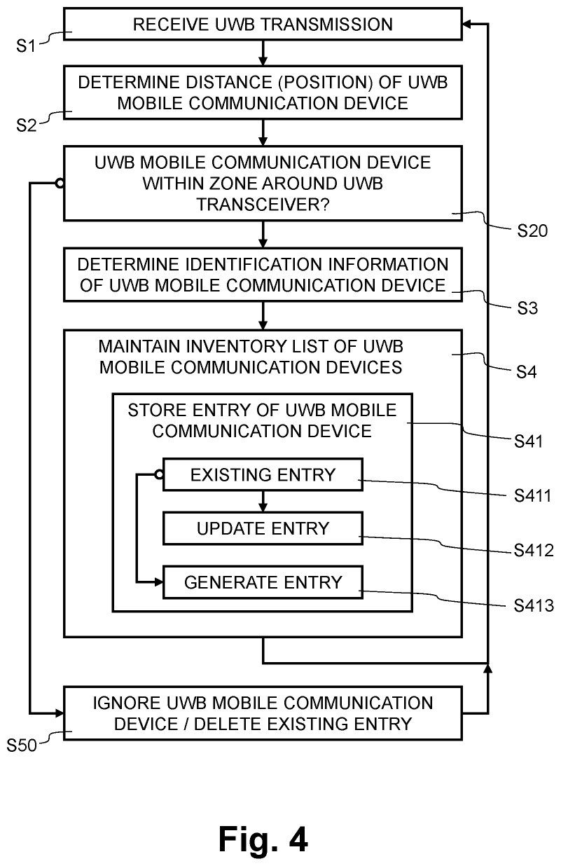

In FIG. 4, the UWB transceiver checks in a step S20, after determining the distance d1, d2, d3, d4, d5 in step S2, whether the UWB mobile communication device 2 is located within the defined zone boundary B of the ultra-wideband transceiver 1. If the UWB mobile communication device 2* is not within the zone boundary B, for example if the distance d1, d2, d3, d4, d5 is greater than a pre-determined threshold distance which defines the zone boundary B, then the UWB mobile communication device 2* is ignored in a step S50. If the UWB mobile communication device 2 is not within the zone boundary B, but an entry exists in the inventory list for that particular UWB mobile communication device 2* (i.e. the device identification information of the UWB mobile communication device 2 matches with device identification information in a stored entry), the UWB transceiver 1 is configured to delete that matching entry. If the UWB mobile communication device 2 is within the zone boundary B, for example if the distance d1, d2, d3, d4, d5 is less than or equal to the pre-determined distance threshold, then the device identification information of the UWB mobile communication device 2 is stored in step S4 as described above.

In a step S41, the UWB transceiver 1 is configured to store an entry of the UWB mobile communication device 2 in the inventory list. The UWB transceiver 1 first checks, in step S411, whether the device identification information of the UWB mobile communication device 2 matches an entry which already exists in the inventory list. If a match is found, the existing entry is updated in step S412, in particular the stored distance is updated with the (current) determined distance d1, d2, d3, d4, d5. If a match is not found, a new entry is generated in step S413.

In an embodiment, the UWB transceiver 1 is configured to periodically determine the presence and the distance d1, d2, d3, d4, d5 of the UWB mobile communication devices 2, by adding to each entry a timestamp indicative of a time point when the UWB transmission(s) T were received. The UWB transceiver 1 is configured to update the entry in step S412 further by updating the timestamp to a current time. The UWB transceiver is further configured to periodically check the inventory list and to delete the given entry from its inventory list if the timestamp of the given entry is older than a pre-determined timeout period. Thereby the UWB transceiver 1 maintains in its data store 12 a continually updated inventory list of UWB mobile communication devices 2 which are in communication range.

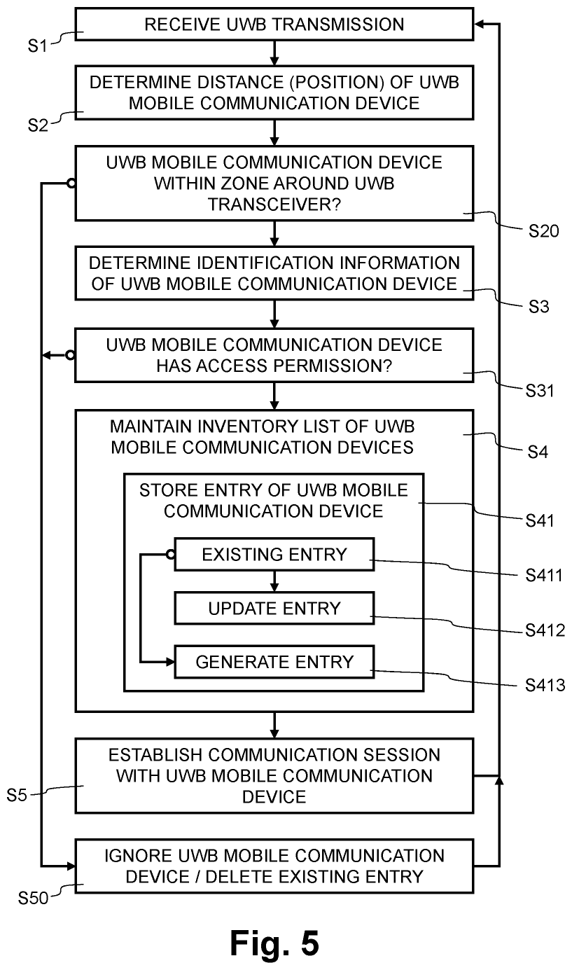

In FIG. 5, the UWB transceiver 1 is configured to check, in step S31, whether the UWB mobile communication device 2 has access permission, as described above. Step S31 is executed by the UWB transceiver 1 between step S3 and step S4. If the UWB mobile communication device 2 does not have access permission, then the UWB transceiver is configured to proceed to step S50, as described above. Further, step S5 is executed only once the UWB mobile communication device 2 has performed step S4, in particular once it has updated or generated the entry as described above.

In an embodiment, the UWB transceiver 1 is configured to check whether the UWB communication device 2 has access permission, which comprises authenticating the UWB communication device 2. By performing the authentication, the UWB transceiver 1 verifies the UWB communication device 2 and/or the user carrying the UWB communication device 2. Authenticating the UWB communication device 2 comprises, in an embodiment, authenticating a cryptographic authentication key received from the UWB communication device 2 in the UWB transceiver 1. Depending on the embodiment, the cryptographic authentication key belongs to a symmetric key-pair or an asymmetric key-pair.

In an embodiment where the UWB transceiver 1 is part of or connected to an access control terminal, the UWB transceiver 1 authenticates the UWB communication device 2 using a cryptographic barrier key associated with a particular barrier, such that access permission of the UWB communication device 2 through the barrier is authenticated. Depending on the embodiment, UWB transceiver 1 is configured to check whether the UWB communication device 2 has access permission prior to determining a distance as described in step S2.

Depending on the embodiment, the cryptographic ranging key, the cryptographic authentication key used by the UWB mobile communication device 2 are either all matching (e.g. identical), two of them matching, or all individual keys.

In an embodiment, the UWB transceiver 1 is further configured to check whether the UWB communication device 2 has access permission by authorizing the UWB communication device 2. Authorizing the UWB communication device 2 requires, for example, receiving and authorizing a cryptographic authorization key received from the UWB communication device 2.

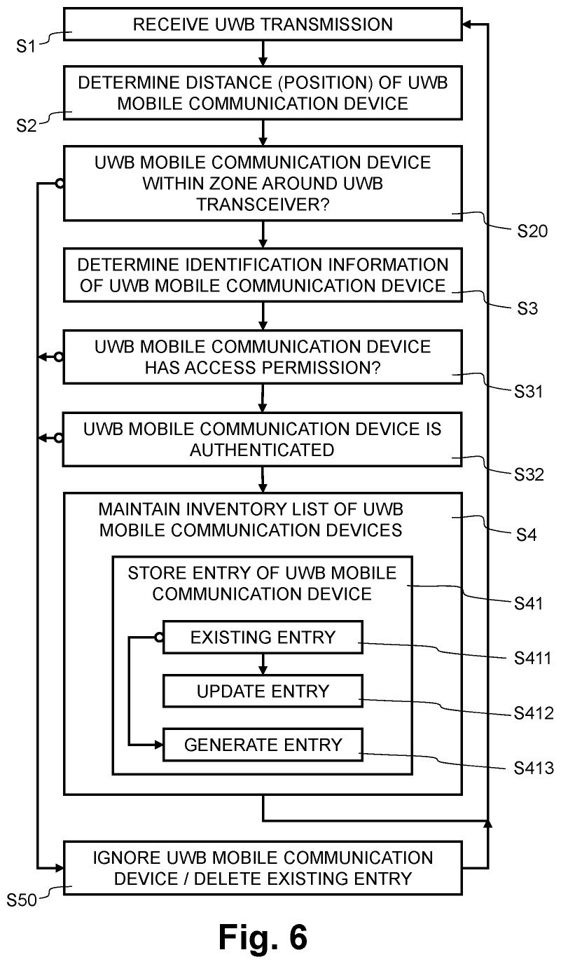

In FIG. 6, in step S32, which is arranged between step S31 and step S4, the UWB transceiver 1 is configured to perform an authentication protocol for establishing authenticity of a particular UWB mobile communication device 2 prior to establishing a communication session with the particular UWB mobile communication device 2. If the particular UWB mobile communication device 2 is not positively authenticated, then the UWB transceiver 1 stops communicating with the UWB mobile communication device 2. If the particular UWB mobile communication device 2 is positively authenticated, then the UWB transceiver 1 moves to step S4 as described above.

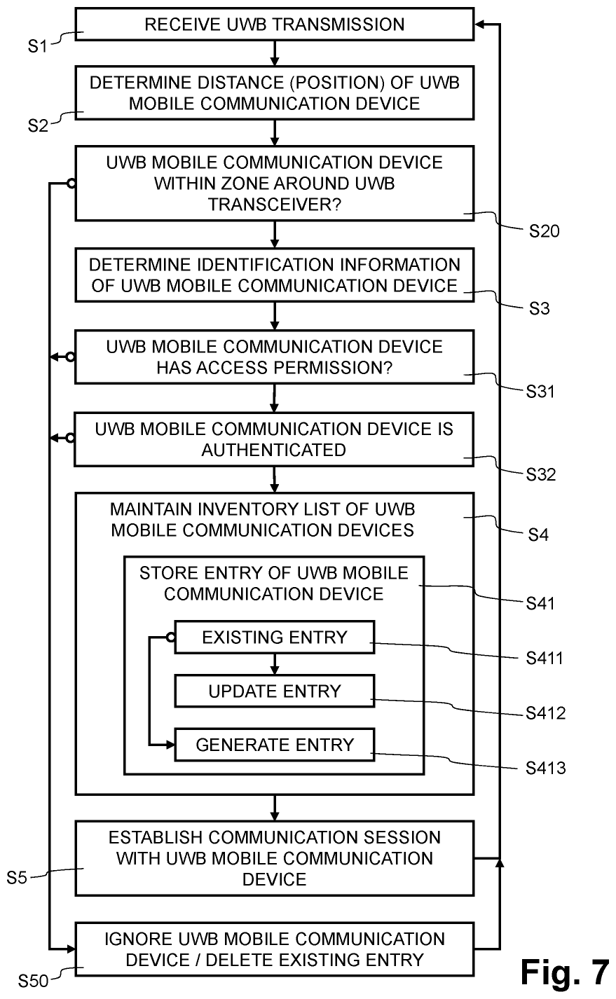

FIG. 7 shows a flow chart similar to FIG. 6, however step S5, as described above, is shown which directly follows step S4.

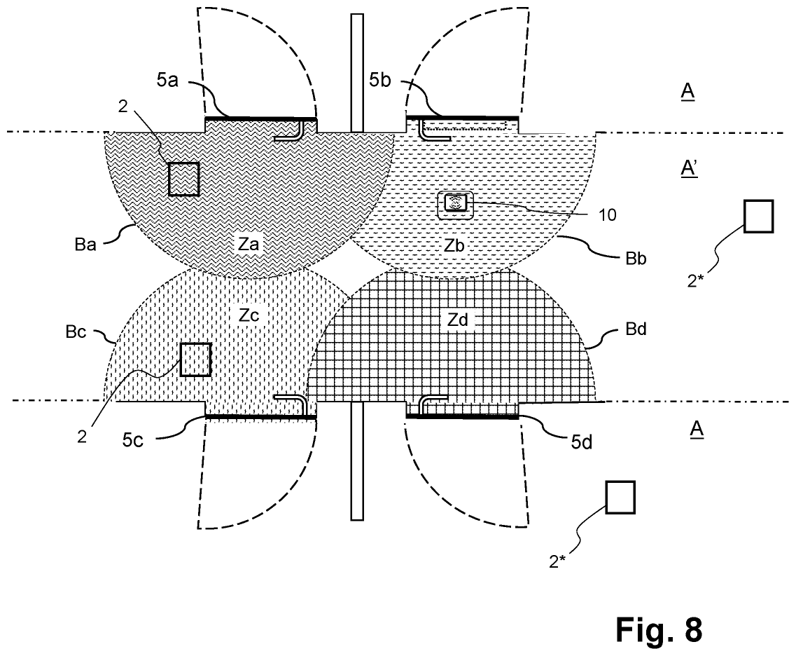

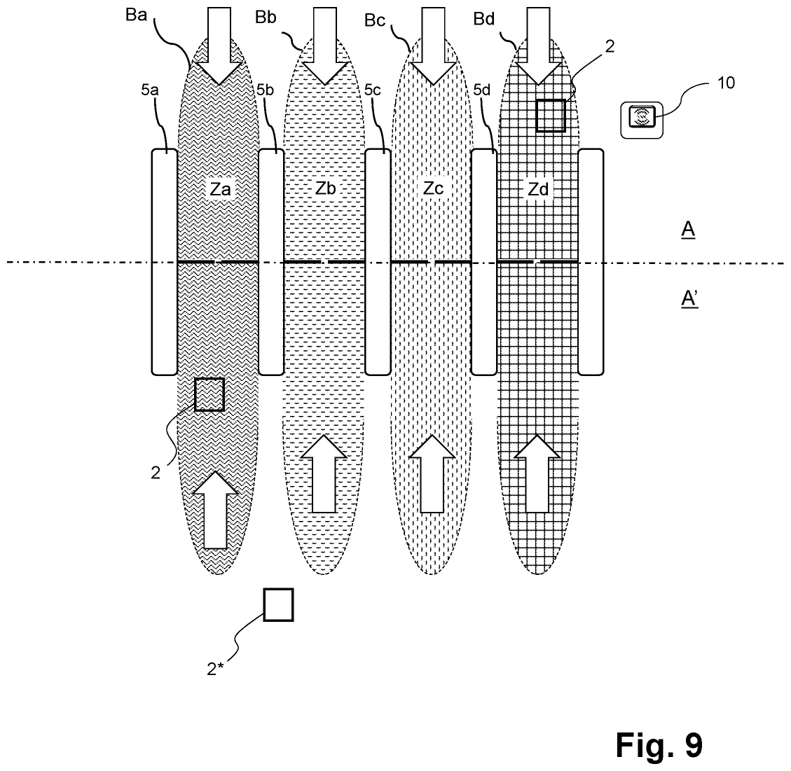

FIGS. 8 and 9 show highly schematic illustrations of an access controlled area A and a complementary area A′ outside the access controlled area A, according embodiments of the invention described below in more detail. According to these embodiments, the UWB transceiver 1 is connected to, or is integrated into, an access control terminal 10. The access control terminal 10, and/or the UWB transceiver 1, along with barriers 5a, 5b, 5c, 5d, are thereby part of an access control system.

In an embodiment, the UWB transceiver 1 is fixedly installed in a wall or ceiling of a room inside or adjacent to an access controlled area A. For example, the UWB transceiver 1 is installed in a recessed in-wall box.

The access controlled area A is, depending on the embodiment, a two-dimensional or three-dimensional area. For example, the access controlled area A is a private or commercial property or located within a private or commercial property. The access controlled area A is, or is located inside, for example, a private home, an office building, a parking garage, a concert hall, a stadium, or a public transportation hub (e.g. a bus stop, train station, or airport). The example of an office building is shown in FIG. 8, where a plurality of barriers 5a, 5b, 5c, 5d, in this example doors, are connected to the access control terminal 10. The example of FIG. 9 is applicable, for example, at a transportation hub where the barriers 5a, 5b, 5c, 5d comprise a movable element which controls access to an access controlled area A.

In an embodiment, the UWB transceiver 1 is connected to an actuator. The actuator is, depending on the embodiment, configured to unlock, open and/or otherwise provide access through or past a barrier 5a, 5b, 5c, 5d. The barrier 5a, 5b, 5c, 5d is, for example, a door, gate, turnstile, or other physical obstruction arranged at an edge of or inside of the access controlled area A. The UWB transceiver 1 is thereby configured to admit or deny access to the access controlled area A for a person or a vehicle in possession of an UWB mobile communication device 2, depending on whether access permission has been granted or denied.

In an embodiment, the actuator is arranged in a separate device to the UWB transceiver 1, for example in the access control device or a separate electronic door lock, while the UWB transceiver 1 is arranged on or in a wall or ceiling close to the door (for example in an access control terminal 10 as described herein).

In another embodiment, the actuator is integrated into the same device as the UWB transceiver 1.

In an embodiment, the UWB transceiver 1 is connected to a plurality of actuators (either directly or via the access control terminal), each actuator related to a particular barrier 5a, 5b, 5c, 5d. For example, the UWB transceiver 1 is connected to a plurality of electronic turnstiles (for example in an office building, train station, or airport), each turnstile having an actuator. The UWB transceiver 1 is thereby configured to admit or deny access to the access controlled area A to a person or vehicle in possession of an UWB mobile communication device 2 depending on whether access permission has been granted or denied.

In an embodiment, the UWB transceiver 1 is configured to store an absolute and/or relative location of each barrier 5a, 5b, 5c, 5d with respect to an installed location of the UWB transceiver 1. In an embodiment, the UWB transceiver 1 is configured to determine a distance and/or direction of movement of the UWB mobile communication devices 2 with respect to each of the barriers 5a, 5b, 5c, 5d.

In an embodiment, the defined zone Z is configured to be non-overlapping with the access controlled area A, such that only UWB mobile communication devices 2 outside the access controlled area A (i.e. in the area A′) can be within the defined zone Z. In such an embodiment, the defined zone Z comprises only UWB mobile communication devices 2 near the access controlled area. Such an example is depicted in FIG. 8.

In another embodiment, the defined zone Z is configured to cover at least part of the access controlled area (i.e. the defined zone Z is contained within the access controlled area), such that only UWB mobile communication devices 2 inside the access controlled area can be within the defined zone Z. In such an embodiment, the defined zone Z comprises only UWB mobile communication devices 2 inside of the access controlled area.

In an embodiment, the defined zone Z overlaps partially with the access controlled area A, such that UWB mobile communication devices 2 inside as well as outside the access controlled area A can be within the defined zone Z. Such an example is depicted in FIG. 9.

In an embodiment, the UWB transceiver 1 is configured to implement a plurality of defined zones Za, Zb, Zc, Zd, having a plurality of defined boundaries Ba, Bb, Bc, Bd, preferably associating each defined zone Z, Za, Zb, Zc, Zd with one of a plurality of barriers 5a, 5b, 5c, 5d. The plurality of defined zones Za, Zb, Zc, Zd overlap with each other, at least partially, as depicted in FIG. 8, or do not overlap with each other, as depicted in FIG. 9.

1. An access control terminal configured to provide physical access to an access controlled area to a person or vehicle in possession of an ultra-wideband mobile communication device with access permission, wherein the access control terminal includes an ultra-wideband transceiver, the ultra-wideband transceiver comprising an electronic circuit and a data store, wherein the electronic circuit is configured to:
receive wirelessly from the ultra-wideband mobile communication device an ultra-wideband transmission;
determine from the ultra-wideband transmission a distance of the ultra-wideband mobile communication device from the ultra-wideband transceiver, and device identification information of the ultra-wideband mobile communication device; and
determine whether the distance of the ultra-wideband mobile communication device from the ultra-wideband transceiver is within a defined zone boundary of the ultra-wideband transceiver; and
maintaining in the data store an inventory list of ultra-wideband mobile communication devices, by storing in the inventory list an entry for the ultra-wideband mobile communication device if the distance of the ultra-wideband mobile communication device from the ultra-wideband transceiver is within the defined zone boundary, wherein the entry for the ultra-wideband mobile communication device comprises the device identification information of the ultra-wideband mobile communication device and the distance of the ultra-wideband mobile communication device from the ultra-wideband transceiver.

2. The access control terminal of claim 1, wherein the electronic circuit is further configured to:
not storing the entry for the ultra-wideband mobile communication device, if the distance, of the ultra-wideband mobile communication device from the ultra-wideband transceiver is not within the defined zone boundary.

3. The access control terminal of claim 1, wherein the electronic circuit is further configured to determine whether the ultra-wideband mobile communication device has access permission, prior to storing the entry for the ultra-wideband mobile communication device, storing the entry for the ultra-wideband mobile communication device, if the ultra-wideband mobile communication device has access permission.

4. The access control terminal of one claim 1, wherein the electronic circuit is further configured to determine whether the ultra-wideband mobile communication device has access permission, establishing a secured communication session with the ultra-wideband mobile communication device, if the ultra-wideband mobile communication device has access permission, and not establishing a secured communication session with the ultra-wideband mobile communication device, if the ultra-wideband mobile communication device does not have access permission.

5. The access control terminal of claim 1, wherein the electronic circuit is further configured to establishing a secured communication session with a defined maximum number of ultra-wideband mobile communication devices entered in the inventory list, whereby priority for establishing a secured communication session is given to the ultra-wideband mobile communication devices reciprocal to their respective distance from the ultra-wideband transceiver.

6. The access control terminal of claim 4, wherein the electronic circuit is configured to perform an authentication protocol for establishing authenticity of the ultra-wideband mobile communication device prior to establishing the secured communication session with the ultra-wideband mobile communication device.

7. The access control terminal of claim 1, wherein the electronic circuit is configured to maintain the inventory list by determining periodically for each of the ultra-wideband mobile communication devices their presence and distances from the ultra-wideband transceiver.

8. The access control terminal of claim 7, wherein the electronic circuit is configured to the inventory list by removing the entry of a particular ultra-wideband mobile communication device from the inventory list when the particular ultra-wideband mobile communication device is no longer present in a communication range of the ultra-wideband transceiver or the distance of the particular ultra-wideband mobile communication device from the ultra-wideband transceiver is not within the defined zone boundary.

9. The access control terminal of claim 1, wherein the electronic circuit is further configured to determine from the ultra-wideband transmission position information of the ultra-wideband mobile communication device, and store the position information in the inventory list in the entry for the ultra-wideband mobile communication device.

10. The access control terminal of claim 9, wherein the electronic circuit is configured to:
determine the position information periodically for the ultra-wideband mobile communication device;
determine, from the position information, movement information for the ultra-wideband mobile communication device; and
store in the inventory list the entry for the ultra-wideband mobile communication device depending on the movement information for the ultra-wideband mobile communication device.

11. The access control terminal of claim 1, wherein the electronic circuit is further configured to:
determine statistical information for the ultra-wideband mobile communication device, the statistical information comprising at least a number of entries of the ultra-wideband mobile communication device in a defined zone around the ultra-wideband transceiver;
store statistical information in the inventory list in the entry for the ultra-wideband mobile communication device; and
store in the inventory list the entry for the ultra-wideband mobile communication device depending on the statistical information for the ultra-wideband mobile communication device.

12. The access control terminal of claim 1, wherein the electronic circuit is configured to determine the device identification information of the ultra-wideband mobile communication device by determining a communication address of the ultra-wideband communication device in the ultra-wideband transmission.

13. The access control terminal of claim 1, wherein the electronic circuit is configured to determine the device identification information of the ultra-wideband mobile communication device by determining in the ultra-wideband transmission a randomized unique identifier of the ultra-wideband communication device.

14. A method of managing mobile communication entities in an access control terminal comprising an ultra-wideband transceiver, the method comprising an electronic circuit of the ultra-wideband transceiver executing the following steps:
receiving wirelessly from an ultra-wideband mobile communication device an ultra-wideband transmission;
determining from the ultra-wideband transmission a distance of the ultra-wideband mobile communication device from the ultra-wideband transceiver, and device identification information of the ultra-wideband mobile communication device; and
maintaining in a data store of the ultra-wideband transceiver an inventory list of ultra-wideband mobile communication devices, by storing in the inventory list an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver.

15. (canceled)

16. An ultra-wideband transceiver fixedly installed in a wall or ceiling of a room inside or adjacent to an access controlled area, comprising an electronic circuit and a data store, wherein the electronic circuit is configured to execute the following steps:
receiving wirelessly from an ultra-wideband mobile communication device an ultra-wideband transmission;
determining from the ultra-wideband transmission a distance of the ultra-wideband mobile communication device from the ultra-wideband transceiver, and device identification information of the ultra-wideband mobile communication device;
maintaining in the data store an inventory list of ultra-wideband mobile communication devices, by storing in the inventory list an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver; and providing access to the access controlled area for a person or a vehicle in possession of the ultra-wideband mobile communication device, provided the ultra-wideband mobile communication device has access permission.

17. An ultra-wideband transceiver, comprising an electronic circuit and a data store, the ultra-wideband transceiver connected to an actuator configured to provide access through a barrier, wherein the electronic circuit is configured to execute the following steps:
receiving wirelessly from an ultra-wideband mobile communication device an ultra-wideband transmission;
determining from the ultra-wideband transmission a distance of the ultra-wideband mobile communication device from the ultra-wideband transceiver, and device identification information of the ultra-wideband mobile communication device;
maintaining in the data store an inventory list of ultra-wideband mobile communication devices, by storing in the inventory list an entry for the ultra-wideband mobile communication device, whereby the entry for the ultra-wideband mobile communication device comprises the device identification information of the ultra-wideband mobile communication device and the distance of the ultra-wideband mobile communication device from the ultra-wideband transceiver; and
providing access through the barrier to the ultra-wideband mobile communication device, provided the ultra-wideband mobile communication device has access permission.
